(19) United States
(12) Patent Application Publication
(10) Pub. No.: US 2012/0219488 A1
(43) Pub. Date: Aug. 30, 2012

(54) CONTINUOUS MANUFACTURE OF CARBIDE DERIVED CARBONS

(75) Inventor: Ranjan Dash, King of Prussia, PA (US)

(73) Assignee: Y-CARBON, INC., Bristol, PA (US)

(21) Appl. No.: 13/371,507

(22) Filed: Feb. 13, 2012

Related U.S. Application Data
(60) Provisional application No. 61/447,191, filed on Feb. 28, 2011.

(51) Int. Cl. C01B 31/02; B01J 19/00

(52) U.S. Cl. 423/445 R; 422/149

(57) ABSTRACT

A reactor apparatus for continuous manufacturing of porous carbon material by halogenation of carbides is provided. The reactor apparatus comprises a sample loading assembly, a reactor positioned within a metal housing and in closed circuit communication with the sample loading assembly, and a material receiving assembly. The sample loading assembly loads samples of carbides into the reactor. The metal housing maintains an inert atmosphere around the reactor. The reactor defines one or more process paths for transporting samples of carbides through a halogen atmosphere and/or a post-treatment atmosphere for yielding porous carbon material. Process vents, positioned on the reactor and the metal housing, pass inert gases and reactant gases past the samples of carbides at predetermined temperatures and exit process gases through a condenser unit. The condenser unit traps metal halide by-products. The material receiving assembly, in closed circuit communication with the reactor, removes and stores the porous carbon material.

### REFERENCES CITED

Y. Gogotsi et al., Nature Materials, 2003
R. Dash, Ph.D. thesis, Drexel University, 2006
R. Dash et al., Carbon, 2006
R. K. Dash et al., Microporous and Mesoporous Materials, 2004
R. K. Dash et al., Microporous and Mesoporous Materials, 2005
J. Chmiola et al., Science, 2010
J. Chmiola et al., Science, 2006
Y. Gogotsi et al., J. Am. Chem. Soc., 2005
Y. Yushin et al., Biomaterials, 2006
C. Portet et al, Phys. Chem. Chem. Phys., 2009

### PATENTS OR APPLICATIONS

W. A. Mohun, Mineral Activated Carbon and Process for Producing Same, U.S. Pat. No. 3,066,099 (1962)
Y. Maletin et. al., Supercapacitor and Method of Making Such a Supercapacitor, U.S. Pat. No. 6,697,249 (2004)
R. Avarbz et. al., Process of Making a Porous Carbon Material and a Capacitor Having the Same, U.S. Pat. No. 5,876,787 (1999)
J. Leis, M. Arulepp, and A. Perkson, Method to Modify Pore Characteristics of Porous Carbon and Porous Carbon Materials Produced by the Method, US Patent Application US 2006/0140846
Y. Gogotsi and M. Barsoum, Nanoporous Carbide Derived Carbon with Tunable Pore Size, US Patent Application 2006/0165584
Y. Gogotsi, G. Yushin, E. Hoffman, E. Nola, and M. Barsoum, Process for Producing Nanoporous Carbide Derived Carbon with Large Specific Surface Area, US Patent Application 2009/0036302
Y. Gogotsi, J. Chmiola, G. Yushin, and R. Dash, Nanocellular High Surface Area Material and Methods for Use and Production Thereof, US Patent Application 2009/0213529
J. Leis, M. Arulepp, M. Latt, and H. Kuura, Method of Making the Porous Carbon Material of Different Pore Sizes and Porous Carbon Materials Produced by the Method, U.S. Pat. No. 7,803,345 (2010)

### BACKGROUND

The reactor apparatus disclosed herein, in general, relates to a system for manufacturing porous carbon. More particularly, the reactor apparatus disclosed herein relates to equipment for continuous manufacturing of porous carbon by halogenation of metal carbides at elevated temperatures.

Carbon materials have found use in many applications, for example, adsorption, energy storage, filtration, etc. Carbide derived carbon represents a method of manufacturing porous carbon from one or more metal carbides by thermo-chemical etching of one or more metals or metalloids by treating with one or more halogens at elevated temperatures.

One challenge in the synthesis of carbide derived carbons is the corrosive nature of halogen(s) at elevated temperatures with respect to the material of the processing equipment. The properties of the carbide derived carbons depend in part on halogenation temperature, and thus the equipment for manufacturing has to be designed so that the metal carbide is exposed to the halogens only at desired temperatures.

Current systems utilize batch processes that are carried out using a fluidized bed, a pack bed, a horizontal tube furnace, or a rotary kiln to produce relatively small amounts of carbide derived carbons. However, these systems limit the amount of material which can be processed, thus limiting the output of the carbide derived carbon material, typically in the order of a few grams per day.

Most of the carbide derived carbon production at present is carried out using a tube furnace and uses chlorine gas as the halogen. In a tube furnace process, a carbide precursor is placed in a quartz or graphite boat, and then loaded into the middle of a quartz tube in the tube furnace. An inlet of the quartz tube is connected to a gas selection manifold, while an outlet is connected to an inlet of a collection flask to condense and collect the metal-halide byproduct(s). An outlet of the collection flask is connected to a bubbler containing alkali or acid solution, which removes the chlorine gas prior to venting to a fume hood in which the setup is placed. To produce the carbide derived carbon materials, the precursor is heated in the tube furnace in an argon rich environment to the desired temperature. Then, the gas feed is switched from argon to chlorine, and the carbide is chlorinated at the desired temperature for the desired time to produce the carbide derived carbon. Following chlorination, the gas feed is switched from chlorine to argon and the furnace is allowed to cool down. Once the furnace cools below 100° C., the carbon derived porous carbon sample is removed.

One existing batch process uses quartz or alumina tubes as reactor chambers which have several disadvantages. Quartz and alumina tubes are difficult to fabricate in larger dimensions. Also, fabrication of complex shapes with quartz and alumina is difficult or impractical. Moreover, quartz tubes cannot be used above 1200° C. Furthermore, the halide ion etches the grain boundary, causing the quartz tube to crack.

The flow of halogens in batch reactors is generally one dimensional, that is, the gas flows from one end to the other end of the reactor, and thus results in non-uniform properties of the material. The material close or upstream to the flow of halogen has different properties than material placed farther or downstream to the flow of halogen.

For a tube furnace, the ratio of the amount of halogen actually required to the stoichiometric amount for complete conversion is of the order of 20 to 60.

Increased tube furnace sizes are associated with poor reaction uniformity. Larger diameter quartz furnace tubes are associated with non-uniform reactor temperature, leading to random pore size production. Preliminary scale-up of the existing batch process has resulted in wide pore size distribution and the presence of metal carbide residues in the final carbide derived carbon materials.

In a rotary reactor, a tube rotates with a solid reactant in the tube while gas flows along the surface of the solid layer. The gaseous reactant should diffuse across the boundary layer on the surface of the rotating solid, and then through the void space in the layer. This diffusion process drastically reduces the overall rate of reaction, sometimes an order of magnitude compared to tube furnace reactors mentioned previously. This diffusion resistance is a disadvantage of the rotary reactor, where the process involves chemical reaction between gas and solids, such as carbide derived carbon, which involves chlorine treatment of metal carbides. This is the reason that the rotary reactor has mainly been used for special cases of gas-solid process systems in which heat transfer and/or thermal decomposition of the solids is the rate-controlling step.

Fluidized beds are also used for the production of carbide derived carbons. The conversion of metal carbide to carbon involves a huge reduction in material density and thus would be extremely challenging to control the flow of gases, particularly when a single reactor is used for making carbide derived carbons from various carbides, which have different starting and final densities. Removal of metal halides is also a challenge as they can contaminate the porous carbon material.

Hence, there is a long felt but unresolved need for a reactor apparatus for continuous large-scale manufacture of porous carbon, for example, in the order of kilograms per day or more, and which may be further scaled to higher quantities, for example, tons per day, by halogenation of metal carbides.

### SUMMARY OF THE INVENTION

The reactor apparatus disclosed herein addresses the above stated need for continuous large-scale manufacture of a porous carbon material by halogenation of carbides. The reactor apparatus comprises equipment for the continuous manufacture of porous carbons by thermo-chemical etching of one or more metals or metalloids by treating with one or more halogens at elevated temperatures. The reactor apparatus enables large scale manufacture of porous carbon, which reduces the cost of making the porous carbon. Also, provided is a method for the large scale continuous manufacture of carbide derived carbons using the reactor apparatus disclosed herein.

Carbide derived carbon synthesis follows the general reaction MₐC_{b}+½cX_{2(g)}→bC+aMX_{c}, where M is a metal or metals, C is carbon or carbon and nitrogen, and X is a halogen. The precursor material comprises, for example, silicon carbide (SiC), silicon carbonitride (SiCN), titanium carbide (TiC), zirconium carbide (ZrC), boron carbide (B₄C), tantalum carbide (TaC), ternary carbides such as titanium aluminum carbide (Ti₂AlC), titanium silicon carbide (Ti₃SiC₂), molybdenum carbide (Mo₂C), and any combination thereof. The halogens comprise, for example, fluorine (F₂), hydrogen fluoride (HF), sulfur tetrafluoride (SF₄), chlorine (Cl₂), bromine (Br₂), and iodine (I₂). The resulting porous carbon retains the microstructure of the precursor material with control of pore size and volume by processing conditions.

The reactor apparatus disclosed herein comprises a sample loading assembly, a metal housing, a reactor made, for example, from graphite positioned within the metal housing, and a material receiving assembly. The sample loading assembly loads samples of carbides, for example, silicon carbide (SiC), silicon carbonitride (SiCN), titanium carbide (TiC), zirconium carbide (ZrC), boron carbide (B₄C), tantalum-carbide (TaC), ternary carbides such as titanium aluminum carbide (Ti₂AlC), titanium silicon carbide (Ti₃SiC₂), molybdenum carbide (Mo₂C), and any combination thereof, into the reactor. The metal carbide samples may incorporate a single metal, or may comprise two or more metals. The reactor is in closed circuit communication with the sample loading mechanism which stores and introduces the precursor metal carbides into the reactor. The metal housing maintains an inert atmosphere such as argon (Ar) around the reactor to prevent oxidation of the graphite enclosure of the reactor and graphite heating elements.

The reactor defines one or more process paths for transporting the samples of metal carbides through one or more of a halogen atmosphere and a post-treatment atmosphere for yielding the porous carbon material. The reactor and the metal housing contain process vents at predetermined positions for introducing and passing inert gases and reactant gases past the samples of the metal carbides at predetermined temperatures and exiting process gases through a condenser unit. The material receiving assembly is in closed circuit communication with the reactor for extracting and storing the porous carbon material.

In an embodiment, the samples of carbides are transported in one or more open sample trays within the reactor apparatus. The sample loading assembly and the material receiving assembly comprise pusher motors for continuous and/or intermittent movement of the sample trays through the process paths and operating zones of the reactor apparatus. The reactor defines operating zones comprising, for example, an entrance zone, a reaction zone, and an exit zone for the carbide samples and the porous carbon material. The sample loading assembly and the material receiving assembly are interchangeable in the reactor apparatus.

In addition to the continuous manufacture of porous carbons in the presence of secondary compounds such as halogens and metal halides absorbed and/or chemically bonded to the carbon, the porous carbons are also post-treated. Currently known methods for removing unwanted species and modifying the surface accomplish post treatment of the micro-porous carbon in atmospheres such as hydrogen, argon, ammonia, carbon dioxide, etc., and such methods are also within the scope of the reactor apparatus disclosed herein.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1A exemplarily illustrates a right perspective view of a reactor apparatus.

FIG. 1B exemplarily illustrates a left perspective view of the reactor apparatus.

FIG. 1C exemplarily illustrates a front orthogonal view of the reactor apparatus.

FIG. 1D exemplarily illustrates a rear orthogonal view of the reactor apparatus.

FIG. 1E exemplarily illustrates a top orthogonal view of the reactor apparatus.

FIG. 2A exemplarily illustrates a front cross-sectional view of the reactor apparatus.

FIG. 2B exemplarily illustrates a front cross-sectional view of the reactor apparatus showing different zones of operation.

FIG. 2C exemplarily illustrates a side cross-sectional view of the reactor apparatus.

FIG. 3 exemplarily illustrates a right perspective view of a condenser unit of the reactor apparatus.

FIG. 4A exemplarily illustrates a front cross-sectional view of the condenser unit.

FIG. 4B exemplarily illustrates a side cross-sectional view of the condenser unit.

FIG. 4C exemplarily illustrates a top cross-sectional view of the condenser unit.

FIG. 5 exemplarily illustrates a front orthogonal view of the reactor apparatus in conjunction with the condenser unit.

FIG. 6 exemplarily illustrates a process flow diagram for continuous manufacturing of porous carbon material by halogenation of carbides.

### DETAILED DESCRIPTION OF THE INVENTION

Detailed descriptions of the embodiments of the present invention are provided below; however it should not be interpreted that the present invention is limited to these descriptions.

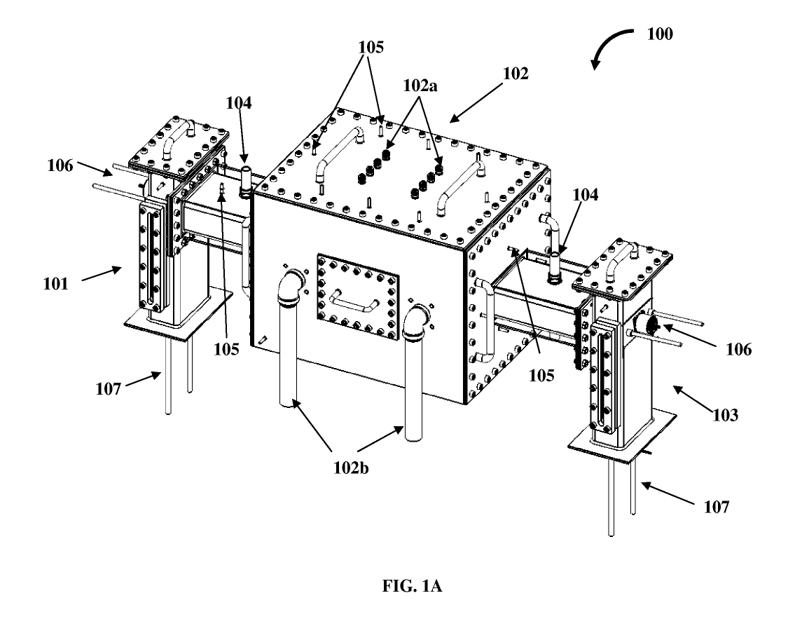

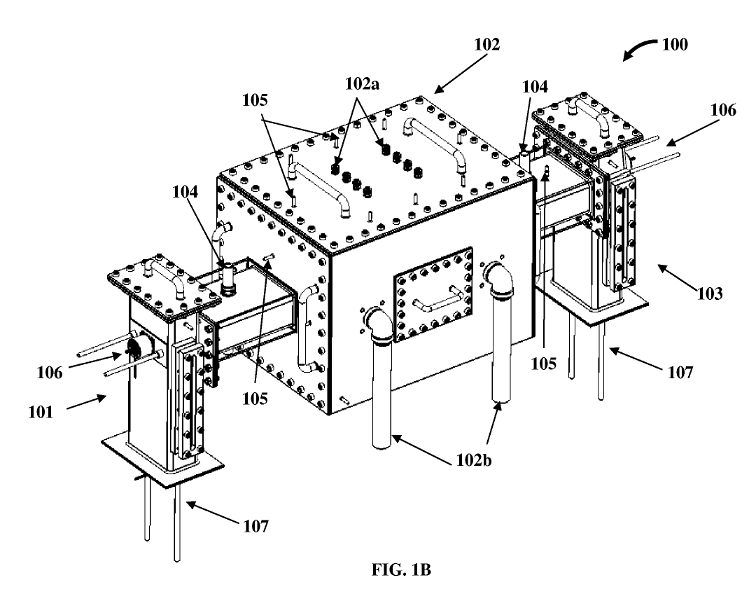

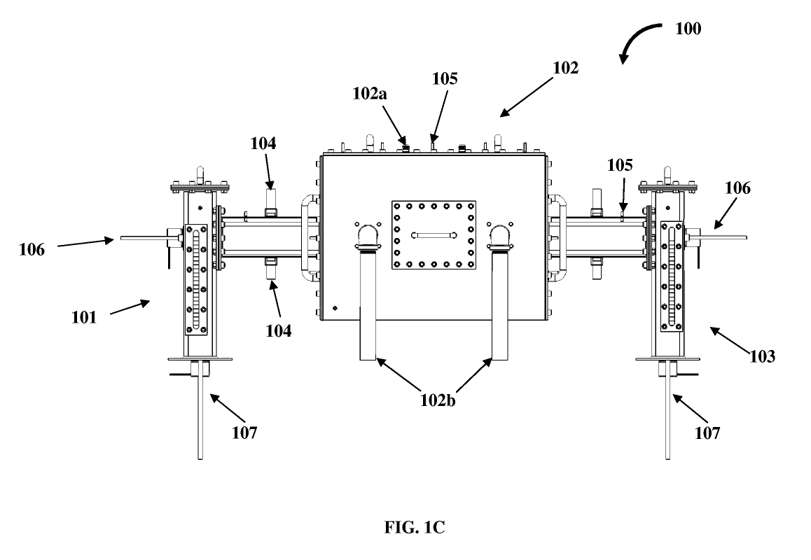

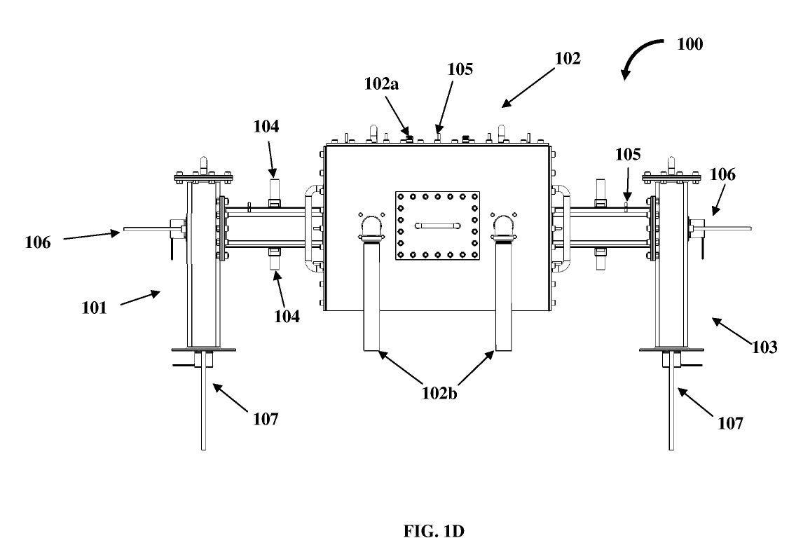

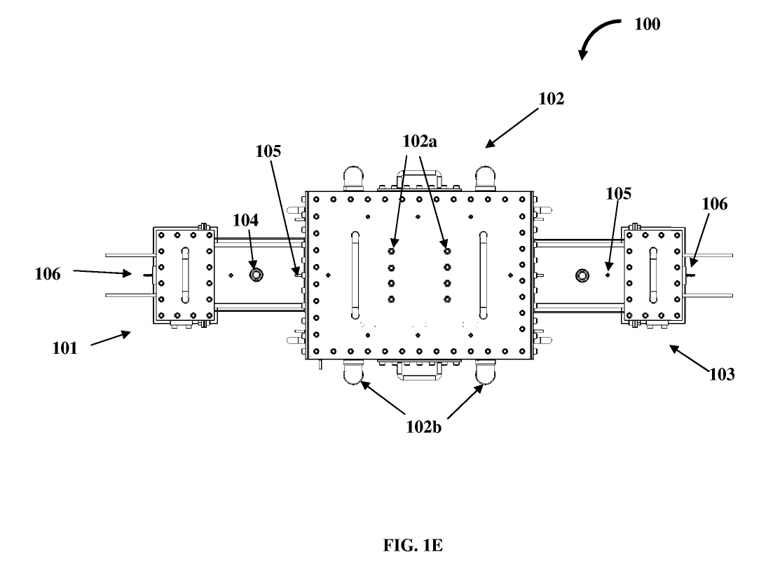

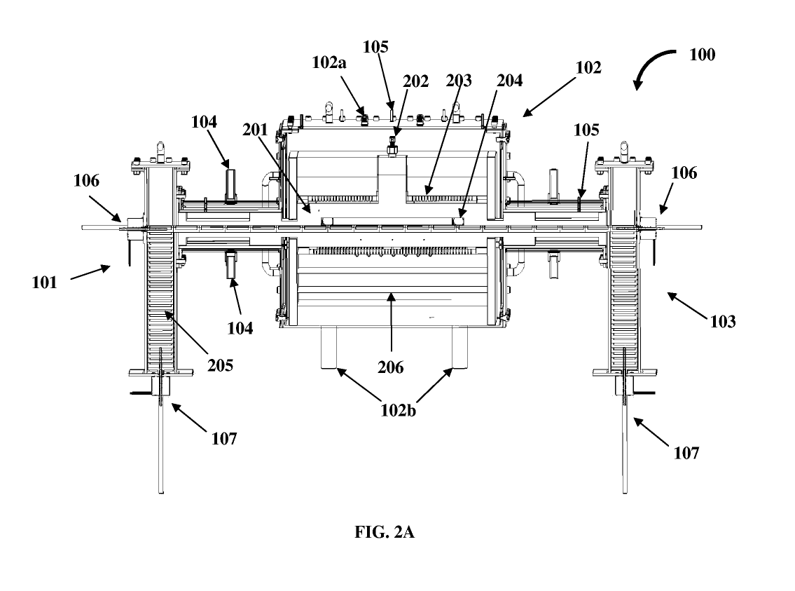

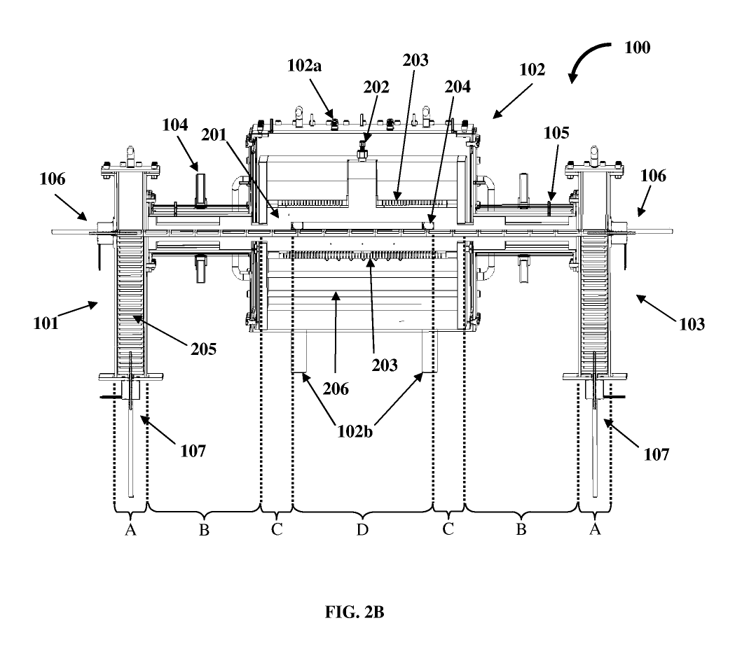

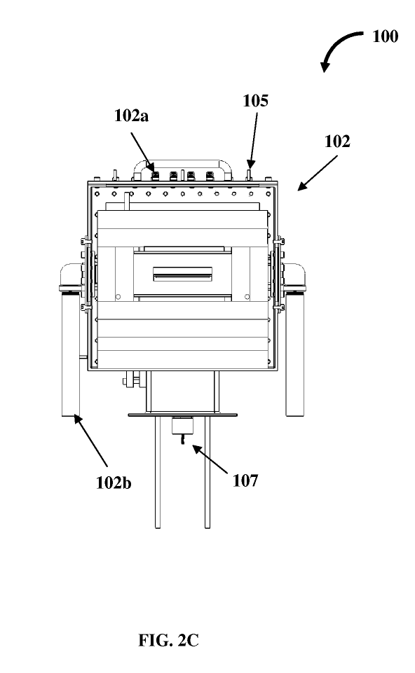

FIG. 1A exemplarily illustrates a right perspective view of a reactor apparatus 100 for continuous manufacture of porous carbon material by halogenation of carbides at elevated temperatures. The reactor apparatus 100 disclosed herein comprises a sample loading assembly 101, a metal housing 102, a reactor 201 made, for example, from graphite positioned within the metal housing 102 as exemplarily illustrated in FIGS. 2A-2B, and a material receiving assembly 103. Since the flow of material within the reactor apparatus 100 is bidirectional, the sample loading assembly 101 and the material receiving assembly 103 are interchangeably used depending on the stage of a treatment process. The sample loading assembly 101 loads samples of the carbides into the reactor apparatus 100, for example, by using a pusher style drive system comprising pusher motors 106 and 107 as exemplarily illustrated in FIGS. 1A-1D. The reactor 201 made of, for example, a graphite enclosure is in closed circuit communication with the sample loading assembly 101 which stores and introduces the precursor metal carbides into the reactor 201. The metal housing 102 maintains an inert atmosphere around the reactor 201 to prevent oxidation of graphite, the carbon material, and the metal carbide.

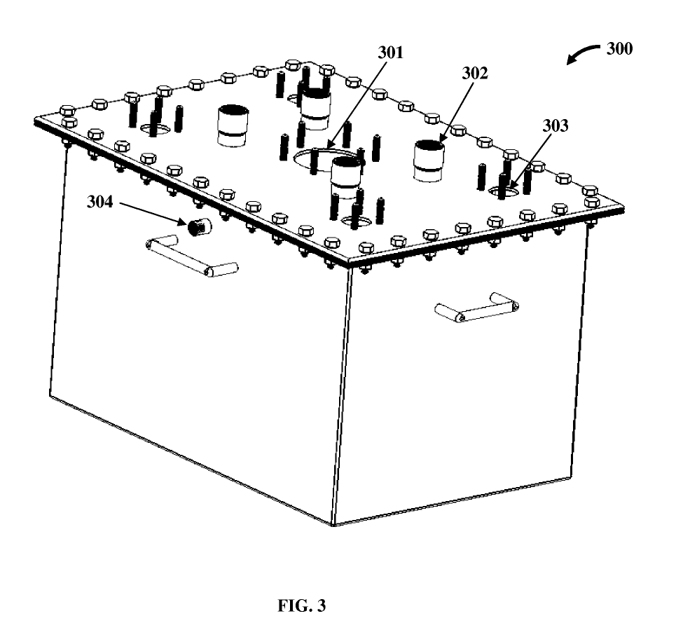

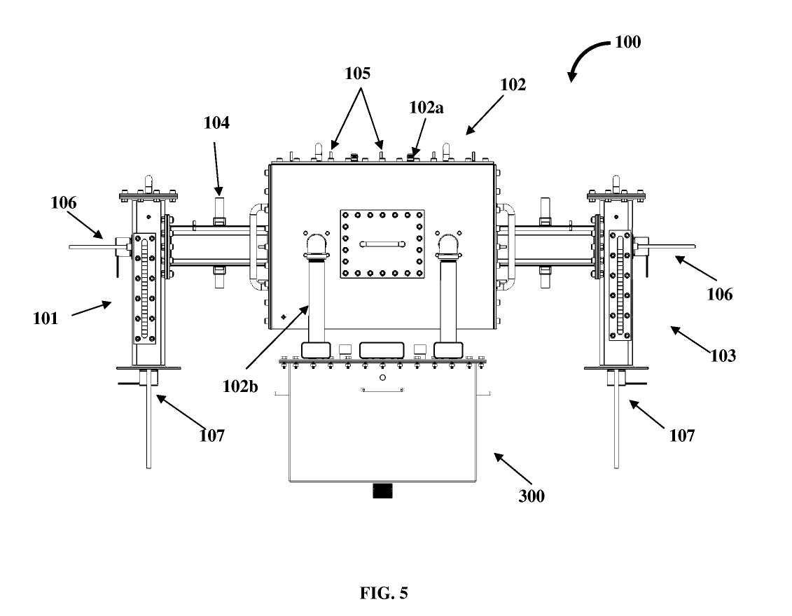

The reactor 201 defines one or more process paths for transporting the samples of carbides through one or more of a halogen atmosphere, a post-treatment atmosphere, and then to the material receiving assembly 103 for yielding the porous carbon material. The reactor 201 and the metal housing 102 comprise process vents, for example, process gas inlets 202, exhaust gas outlets 204, etc., at predetermined positions, as exemplarily illustrated in FIGS. 2A-2B, for introducing and passing inert gases and reactant gases past the metal carbide materials at predetermined temperatures and for removing process gases, for example, metal halide by-products through a condenser unit 300 as exemplarily illustrated in FIG. 3 and FIG. 5. The metal housing 102 comprises necessary feed ports 102a for gas and electricity and an exhaust gas outlet 102b. The material receiving assembly 103 is in closed circuit communication with the reactor 201 for receiving and storing the porous carbon materials.

Carbide derived carbon synthesis follows the general reaction MₐC_{b}+½cX_{2(g)}→bC+aMX_{c}, where M is a metal or metals, C is carbon or carbon and nitrogen, and X is a halogen. The precursor material comprises, for example, silicon carbide (SiC), silicon carbonitride (SiCN), titanium carbide (TiC), zirconium carbide (ZrC), boron carbide (B₄C), tantalum carbide (TaC), ternary carbides such as titanium aluminum carbide (Ti₂AlC), titanium silicon carbide (Ti₃SiC₂), molybdenum carbide (Mo₂C), and any combination thereof. The metal carbide samples may incorporate a single metal, or may comprise two or more metals. The halogens comprise, for example, fluorine (F₂), hydrogen fluoride (HF), sulfur tetrafluoride (SF₄), chlorine (Cl₂), bromine (Br₂), and iodine (I₂). The resulting porous carbon retains the microstructure of the precursor with control of pore size and volume by processing conditions.

In an embodiment, the samples of carbides such as SiC, SiCN, TiC, ZrC, B₄C, TaC, Ti₂AlC, Ti₃SiC₂, Mo₂C, etc., are transported in one or more open sample trays 205 within the reactor apparatus 100 as exemplarily illustrated in FIGS. 2A-2B. The metal carbide materials may incorporate a single metal, or may comprise two or more metals. The carbide samples are contained within the sample trays 205 with depth of field ranging from 0.1 mm to 20 mm. In an example, the carbide samples comprise carbide powder pressed in the form of pellets. The carbide samples fed to the reactor 201 may be in the form of, for example, powder, monolith, foam, or a combination thereof. The sample loading assembly 101 and the material receiving assembly 103 comprise pusher motors 106 and 107, for example, vertical pusher motors 107 and horizontal pusher motors 106 for manual and/or automatic and continuous and/or intermittent movement of the sample trays 205 through the process paths and operating zones A, B, C, and D of the reactor apparatus 100 as exemplarily illustrated in FIG. 2B. The reactor 201 defines an entrance zone, a reaction zone, and an exit zone for processing the carbide samples and the porous carbon material.

FIGS. 1B-1E exemplarily illustrate the external structure of the reactor apparatus 100 for manufacturing carbon materials from metal carbides. FIG. 1B exemplarily illustrates a left perspective view of the reactor apparatus 100. FIG. 1C exemplarily illustrates a front orthogonal view of the reactor apparatus 100. FIG. 1D exemplarily illustrates a rear orthogonal view of the reactor apparatus 100. FIG. 1E exemplarily illustrates a top orthogonal view of the reactor apparatus 100. The reactor apparatus 100 is fabricated from, for example, stainless steel or the like. The reactor apparatus 100 is sealed to atmosphere and purged with an inert gas such as argon (Ar). The reactor apparatus 100 comprises inert gas purge connections 105 for purging the reactor apparatus 100 with the inert gas. The reactor apparatus 100 comprises feed ports 102a for gas and electricity, and an exhaust gas outlet 102b. The structure of the reactor apparatus 100 is water cooled using water cooling connections 104. Electro-mechanical drive motors, for example, the horizontal pusher motors 106 and the vertical pusher motors 107 move the sample trays 205 through the reactor apparatus 100.

FIG. 2A exemplarily illustrates a front cross-sectional view of the reactor apparatus 100. FIG. 2B exemplarily illustrates a front cross-sectional view of the reactor apparatus 100 showing different zones of operation A, B, C, and D. FIG. 2B also illustrates the interior components of the reactor apparatus 100. FIG. 2C exemplarily illustrates a side cross-sectional view of the reactor apparatus 100. The reactor apparatus 100 comprises, for example, four operating zones, namely, a sample tray zone A, a cooling zone B, a pre-heating/de-gassing zone C, and a reaction/process zone D. The reactor 201 is heated by one or more external heating elements 203. The reactor 201 and the heating elements 203 are made of, for example, graphite. As exemplarily illustrated in FIG. 2B, the reaction/process zone D of the reactor 201 is insulated by insulation media 206, for example, ceramic insulation of silica, alumina, zirconia, etc. In an embodiment, in order to maintain a balanced system, the entire length of the reactor 201 is required to contain the sample trays 205. The reactor 201 comprises a process gas inlet 202 for introducing the process or reactant gas into the reaction/process zone D and exhaust gas outlets or process vents 204 for venting the process gas out of the reaction/process zone D.

The post treatment of the porous carbon within the reactor apparatus 100 is performed with one of the following objectives:

1. Change in chemistry of the surface of the carbide derived carbon.

2. Altering the porosity of the material of the carbide derived carbon.

3. Altering the chemical composition of the carbide derived carbon.

Hydrogen and ammonia are used to drive off the residual halogens or their halides. Argon gas is used as an inert gas while the post treatment is performed at elevated temperatures. The amount of residual halogens or their halides are decreased under argon treatment at elevated temperatures but they are less effective as compared to the hydrogen and ammonia treatment. Also, the hydrogen and ammonia treatment results in functionalization of the carbon surfaces.

Carbon dioxide is used to alter the porosity of the carbide-derived carbons by controlled oxidation of the surface. While the primary objective of carbon dioxide treatment is to alter the porosity of carbide derived carbons, the carbon dioxide treatment also results in decrease in halogen and/or halide content. In addition to carbon dioxide, a common activation agent such as oxygen, moisture, sodium hydro-oxide, potassium hydro-oxide, zinc chloride, phosphoric acid, may be used.

### EXAMPLE 1

This example relates to a single-step process. In this case, the feed is processed in one direction only under a single set of conditions. In an embodiment, empty trays and sample trays 205 filled and accurately weighed with a carbide material are loaded into the sample tray zone A. The empty trays, located both before and after the filled sample trays 205, are required to completely move or push the sample trays 205 with the material through the reactor 201 to the opposite sample tray zone A. The sample trays 205 are positioned such that the first sample tray 205 with the material is located in the pre-heating/de-gassing zone C. Prior to and during heating of the reactor 201, an inert gas such as argon is passed through the reactor 201. At all times, the reactor apparatus 100 is purged with an inert gas, for example, argon. The reactor 201 is heated to a predetermined temperature and is allowed to stabilize. A process or reactant gas is then introduced into the reaction/process zone D displacing the inert gas. The process or reactant gas comprises, for example, a halogen gas, inert gas, carbon monoxide (CO), carbon dioxide (CO₂), water (H₂O), ammonia (NH₃), hydrogen (H₂), and their mixtures. The sample trays 205 are moved continuously or in a step-wise motion or continuous motion through the reactor 201. The sample process time, that is the time the sample tray 205 is in the reaction/process zone D can be determined as follows:

$$\begin{matrix}t = \frac{l}{v} \\ or & ( 1 ) \\ t = \frac{l * {t}_{step}}{d} & ( 2 )\end{matrix}$$

where “t” is the process time, “1” is the length of the reaction/process zone D, “v” is the velocity of the sample tray 205, “tₛₜₑₚ” is the time between pushes, and “d” is the distance between pushes. Processing continues until all the sample trays 205 with the material have passed though the reaction/process zone D. After the process is complete, the process or reactant gas is stopped and inert gas flow is resumed. The remaining sample trays 205 in the reactor 201 are pushed into the sample tray zone A in the material receiving assembly 103 for removal.

### EXAMPLE 2

This example relates to a multi-step process. In this case, materials undergo processing in one direction at certain conditions, followed by processing in the opposite direction under different conditions, without removing the materials. In the multi-step process, there is no limit to the number of process steps. In an embodiment, empty trays and sample trays 205 filled and accurately weighed with a carbide material are loaded into the sample tray zone A. The empty trays, located both before and after the filled sample trays 205, are required to completely move or push the sample trays 205 with the material through the reactor 201 to the opposite sample tray zone A. The sample trays 205 are positioned such that the first sample tray 205 with the material is located in the pre-heating/de-gassing zone C. Prior to and during heating of the reactor 201, an inert gas such as argon is passed through the reactor 201. At all times, the reactor apparatus 100 is purged with an inert gas, for example, argon. The reactor 201 is heated to a predetermined temperature and is allowed to stabilize. The inert gas is then stopped and a process or reactant gas is passed into the reaction/process zone D. The process or reactant gas comprises, for example, a halogen gas, inert gas, CO, CO₂, H₂O, NH₃, H₂, and their mixtures, etc. The sample trays 205 are moved through the reactor 201 continuously or in an intermittent fashion, for example, moved a certain distance and momentarily stopped. The sample process time can be determined using the equations (1) and (2) above. Processing continues until all the sample trays 205 with the material have passed though the reaction/process zone D. After the process is complete, the process gas and the temperature are changed for the subsequent processing conditions and allowed to stabilize. The sample trays 205 are then moved continuously or in an intermittent or step-like motion in the opposite direction through the reactor 201. The sample process time can be determined using the equations (1) and (2). Processing continues until all the sample trays 205 with the material have passed though the reaction/process zone D. The remaining sample trays 205 in the reactor 201 are pushed into the sample tray zone A on the receiving side for removal.

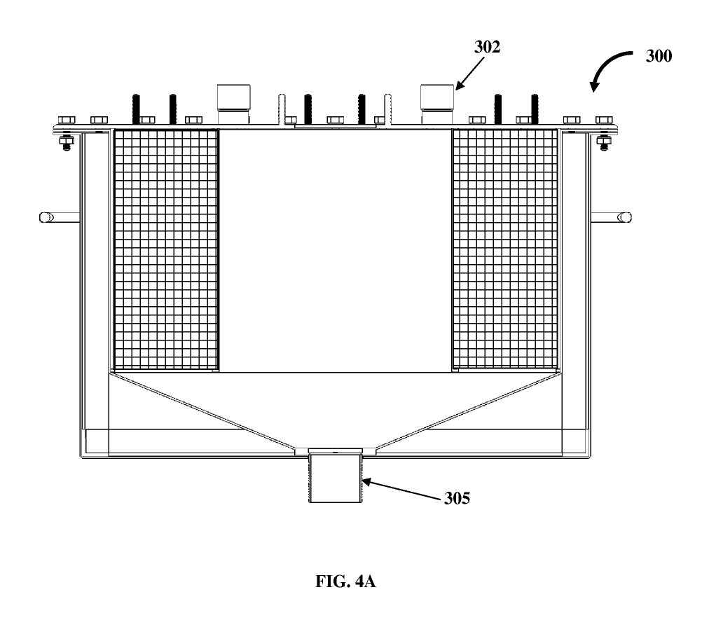

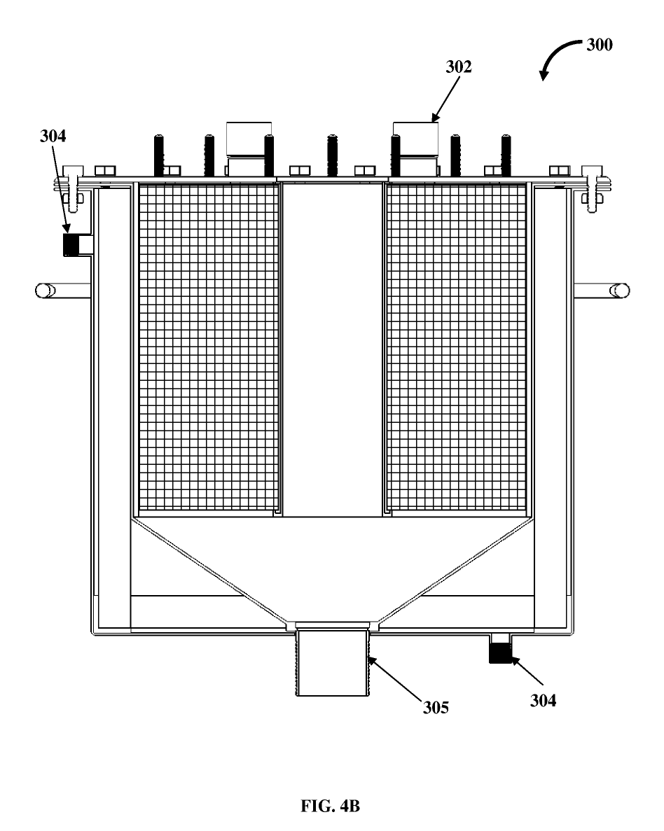

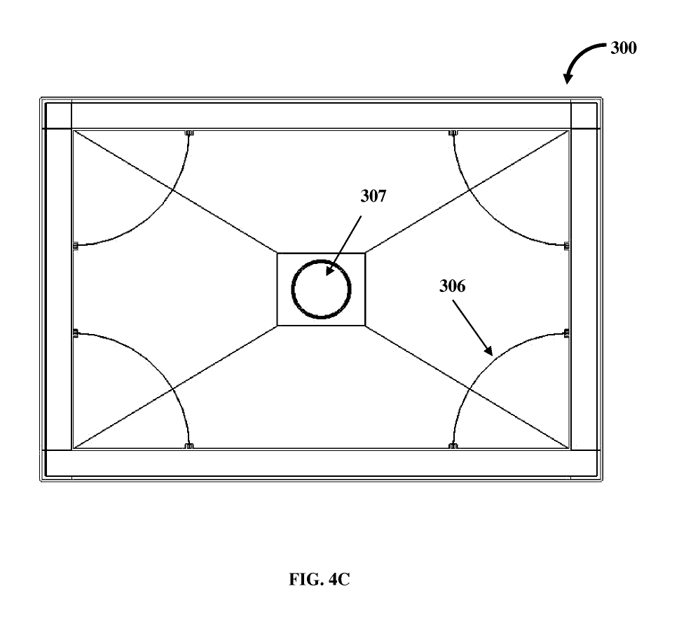

FIG. 3 exemplarily illustrates a right perspective view of a condenser unit 300 of the reactor apparatus 100. The condenser unit 300 comprises an accessory port 301, an exhaust port 302, an inlet port 303, a water cooling connection 304 as exemplarily illustrated in FIG. 3 and FIG. 4B, and a drain connection 305 as exemplarily illustrated in FIGS. 4A-4B. The condenser unit 300 is cooled to trap the metal halides. Metal halides exit the reactor 201 through the process vents 204 of the reactor 201 and the exhaust gas outlet 102b into the inlet port 303 of the condenser unit 300. Metal halides condense on the mesh baffle 306 illustrated in FIG. 4C, and fall to the bottom of the condenser unit 300. Non-metal halide process gasses exit the condenser unit 300 through the exhaust port 302 and continue to a neutralization process such as a chemical scrubber. The accessory port 301 provides access to the metal halide material for processing or reacting.

FIG. 4A exemplarily illustrates a front cross-sectional view of the condenser unit 300. FIG. 4B exemplarily illustrates a side cross-sectional view of the condenser unit 300. FIG. 4C exemplarily illustrates a top cross-sectional view of the condenser unit 300. Metal halides condense on the mesh baffle 306 of the condenser unit 300 and fall to the bottom of the condenser unit 300. A drain 307 allows for removal of the metal halide or processed/reacted material and cleaning of the condenser unit 300.

FIG. 5 exemplarily illustrates a front orthogonal view of the reactor apparatus 100 in conjunction with the condenser unit 300. Metal halides exit the reactor 201 through the process vents 204 of the reactor 201 and the exhaust gas outlet 102b into the inlet port 303 of the condenser unit 300. Metal halides condense on the mesh baffle 306 illustrated in FIG. 4C, and fall to the bottom of the condenser unit 300.

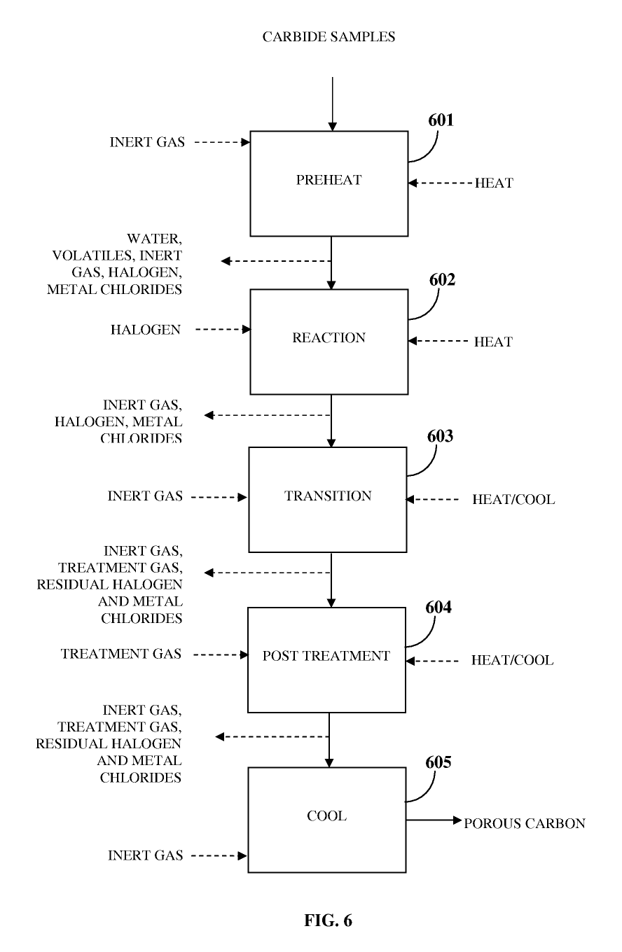

Also disclosed herein is a method for continuous manufacture of porous carbon by halogenations of carbides. FIG. 6 exemplarily illustrates a process flow diagram for continuous manufacturing of porous carbon material by halogenation of carbides. The reactor apparatus 100, as disclosed in the detailed description of FIGS. 1A-1E and FIGS. 2A-2C, is provided. The reactant gases and the inert gases are introduced and passed over the samples of carbides at predetermined temperatures in a single-step process or a multi-step process at predetermined temperatures and in one of a unidirectional mode and a bidirectional mode for yielding the porous carbon material by the halogenation of the carbides. The porous carbon material undergoes in situ post treatment for modifying surface characteristics of the porous carbon material and for removing unwanted species from the porous carbon material. Metal halides generated during the continuous manufacture of the porous carbon material by the halogenation of carbides are condensed in the condenser unit 300 to trap the metal halides.

As exemplarily illustrated in FIG. 6, the carbide precursor samples comprising, for example, silicon carbide (SiC), silicon carbonitride (SiCN), titanium carbide (TiC), zirconium carbide (ZrC), boron carbide (B₄C), tantalum carbide (TaC), ternary carbides such as titanium aluminum carbide (Ti₂AlC), titanium silicon carbide (Ti₃SiC₂), molybdenum carbide (Mo₂C), or any combination thereof are preheated 601 to a desired temperature in the presence of an inert gas such as argon (Ar). The by-products that may result in this preheating step 601 comprise, for example, water, volatiles, the inert gas, halogens, and metal chlorides. A process or reactant gas, for example, a halogen such as Cl₂ (g), Br₂ (g) is introduced in the reactor 201 for the reaction step 602 comprising, for example, halogenation of the metal carbides at a predetermined temperature for yielding the porous carbon material. The reactant gas is replaced by the inert gas in the transition step 603, followed by a post treatment step 604 where the porous carbon material undergoes post treatment using treatment gases, for example, Ar, H₂, NH₃, CO₂, etc., at different temperature conditions. The reactor 201 is cooled in the presence of the inert gas in the cooling step 605 and the porous carbon material is removed at the material receiving assembly 103 of the reactor apparatus 100.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A reactor apparatus for continuous manufacturing of porous carbon material by halogenation of carbides, comprising:
a sample loading assembly for loading samples of said carbides;
a metal housing;
a reactor positioned within said metal housing and in closed circuit communication with said sample loading assembly, wherein said metal housing maintains an inert atmosphere around said reactor, said reactor defining:
one or more process paths for transporting said samples of said carbides through one or more of a halogen atmosphere and a post-treatment atmosphere for yielding said porous carbon material, wherein said reactor and said metal housing comprise process vents at predetermined positions for introducing and passing inert gases and reactant gases past said samples of said carbides at predetermined temperatures and exiting process gases through a condenser unit; and
a material receiving assembly in closed circuit communication with said reactor for extracting and storing said porous carbon material.

2. The reactor apparatus of claim 1, wherein said sample loading assembly and said material receiving assembly are interchangeable.

3. The reactor apparatus of claim 1, wherein said samples of said carbides are transported in one or more open sample trays.

4. The reactor apparatus of claim 1, wherein said reactor defines an entrance zone, a reaction zone, and an exit zone for said samples of said carbides and said porous carbon material.

5. The reactor apparatus of claim 1, wherein said sample loading assembly and said material receiving assembly comprise pusher motors for one of continuous and intermittent movement of sample trays through said process paths and operating zones of said reactor apparatus.

6. A method for continuous manufacturing of porous carbon material by halogenation of carbides, comprising:
providing a reactor apparatus comprising:
a sample loading assembly for loading samples of said carbides;
a metal housing;
a reactor positioned within said metal housing and in closed circuit communication with said sample loading assembly, wherein said metal housing maintains an inert atmosphere around said reactor, said reactor defining:
one or more process paths for transporting said samples of said carbides through one or more of a halogen atmosphere and a post-treatment atmosphere for yielding said porous carbon material, wherein said reactor and said metal housing comprise process vents at predetermined positions for introducing and passing inert gases and reactant gases past said samples of said carbides at predetermined temperatures and exiting process gases through a condenser unit; and
a material receiving assembly in closed circuit communication with said reactor for extracting and storing said porous carbon material;
introducing and passing said reactant gases and said inert gases past said samples of said carbides at said predetermined temperatures in one of a single-step process and a multi-step process for yielding said porous carbon material by halogenation of said carbides; and
post treating, in situ, said porous carbon material for modifying surface characteristics of said porous carbon material.

7. The method of claim 6, further comprising condensing metal halides in said condenser unit, wherein said metal halides are generated during said continuous manufacture of said porous carbon material by said halogenation of said samples of said carbides.
